(19) United States
(12) Patent Application Publication
(10) Pub. No.: US 2026/0268899 A1
(43) Pub. Date: Sep. 10, 2026

(54) SYSTEMS AND METHODS FOR CONTEXTUAL CONTROL OF VOICE-ACTIVATED FEATURES

(71) Applicant: Honda Motor Co., Ltd., Tokyo (JP)

(72) Inventor: Andrew R. HOOVER, West Liberty, OH (US)

(21) Appl. No.: 19/075,232

(22) Filed: Mar. 10, 2025

(51) Int. Cl. G10L 15/22

(52) U.S. Cl. CPC G10L 15/22; G10L 2015/223

(57) ABSTRACT

A vehicle, vehicle controller, and method of operating a vehicle controller to contextually activate voice control components of communicatively coupled computing devices are described herein. The vehicle controller is configured to detect, using at least one audio capture device, a verbal activation command issued by a requestor, detect a position of the requestor relative to at least one of the vehicle and the at least one audio capture device, and, based on the position of the requestor, identify a first computing device to respond to the verbal activation command. The vehicle controller is further configured to activate a voice assistant functionality of the first computing device in response to the verbal activation command.

### FIELD OF THE INVENTION

The present disclosure relates to voice assistant technology and, more particularly, to a systems and methods for contextual control of voice-activated features relative to an environment in which the voice-activated feature is requested.

### BACKGROUND

The use of voice assistants has grown rapidly as such assistants have advanced in recognition technologies and as the use of “smart devices” has increased. Recently, a feature in which voice assistants can be activated from a dormant state, even when a user is not in close proximity to a device, has been developed, sometimes referred to as a “barge-in” command. However, when the user is attempting to activate one device from a distance, other device(s) may also detect the user's same command, which can lead to unintended results on unintended devices, for example. Accordingly, a context aware system for voice-activated features would be desirable.

### BRIEF SUMMARY

In one aspect, a vehicle controller is provided. The vehicle controller is associated with a vehicle and includes at least one memory device, at least one audio capture device, and at least one processor in communication with the at least one memory device and the at least one audio capture device. The at least one processor is programmed to detect, using the at least one audio capture device, a verbal activation command issued by a requestor, detect a position of the requestor relative to at least one of the vehicle and the at least one audio capture device, and, based on the position of the requestor, identify a first computing device to respond to the verbal activation command. The processor is further programmed to activate a voice assistant functionality of the first computing device in response to the verbal activation command. The vehicle controller may have additional, less, or alternate functionality, including that discussed elsewhere herein.

In another aspect, a vehicle is provided. The vehicle includes a plurality of sensors disposed within and exterior to the vehicle, and a vehicle controller on-board the vehicle. The vehicle controller includes at least one memory device, at least one audio capture device, and at least one processor in communication with the at least one memory device and the at least one audio capture device. The at least one processor is programmed to detect, using the at least one audio capture device, a verbal activation command issued by a requestor, detect a position of the requestor relative to at least one of the vehicle and the at least one audio capture device, and, based on the position of the requestor, identify a first computing device to respond to the verbal activation command. The processor is further programmed to activate a voice assistant functionality of the first computing device in response to the verbal activation command. The vehicle may have additional, less, or alternate functionality, including that discussed elsewhere herein.

In still another aspect, a method for contextually activating voice control components of communicatively coupled computing devices is provided. The method is implemented by a vehicle controller including at least one memory device, at least one audio capture device, and at least one processor in communication with the at least one memory device and the at least one audio capture device. The method includes detecting, using the at least one audio capture device, a verbal activation command issued by a requestor, detecting a position of the requestor relative to at least one of the vehicle and the at least one audio capture device, and, based on the position of the requestor, identifying a first computing device to respond to the verbal activation command. The method also includes activating a voice assistant functionality of the first computing device in response to the verbal activation command. The method may have additional, fewer, or alternate steps, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a schematic diagram of an exemplary vehicle, in accordance with one embodiment of the present disclosure;

FIG. 2 is a block diagram of an exemplary vehicle control system that may be used with the vehicle shown in FIG. 1;

FIG. 3 is a partial schematic view of the vehicle shown in FIG. 1 including the vehicle control system shown in FIG. 2;

FIG. 4 illustrates an exemplary flowchart of a process for contextual control of voice-activated features using the systems shown in FIGS. 1 and 3; and

FIG. 5 is a block diagram of an exemplary user computing device that may be used with the systems shown in FIGS. 1-3.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, voice assistant technology and, more particularly, to context-aware voice assistant technology. In many instances, voice assistants may be activated by a verbal command issued by a user. Some common examples include “OK, Google,” to activate GOOGLE ASSISTANT; “Alexa,” to activate AMAZON ALEXA; or “Hey, Siri,” to activate APPLE'S SIRI. These “voice assistants” are software programs implemented on computing devices that enable voice commands to control certain functions of the computing device and/or other devices connected thereto. Many users appreciate and utilize this voice-control functionality, because they are able to activate the voice assistant and perform various tasks without necessarily being in physical contact with their computing device.

When multiple computing devices are available to a requestor (e.g., a driver of a vehicle, an occupant of a vehicle, etc.) issuing a verbal activation command (referred to hereinafter as a requestor), the system of the present disclosure facilitates ensuring the appropriate or correct computing device is activated in response to the requestor's command. Available devices may include computing devices that are located in close enough proximity to the requestor to capture the verbal activation command via their respective input device (e.g., microphone). Based on where the requestor is relative to the input devices or computing devices, whether there are multiple persons, and other contextual sensor data, for example, the system of the present disclosure determines which computing device is the intended or appropriate receiver of the verbal activation command. Moreover, the system identifies the intended computing device, from the multiple available computing devices in proximity to the requestor, and activates the voice assistant functionality of that intended computing device.

At least one of the technical problems addressed by this system may include: (i) reducing or eliminating unintended activation of computing devices; (ii) improving the accuracy and responsiveness of voice assistant technology; and (iii) improving the overall safety of vehicle operators by activating only appropriate/intended computing devices to thus facilitate minimizing distraction within the vehicle.

The methods and systems described herein may be implemented using computer programming or engineering techniques including computer software, firmware, hardware, or any combination or subset thereof, wherein the technical effects may be achieved by performing at least one of the following steps: a) detecting, using the at least one audio capture device, a verbal activation command issued by a requestor, b) detecting a position of the requestor relative to at least one of the vehicle and the at least one audio capture device, c) based on the position of the requestor, identifying a first computing device as an intended recipient of the verbal activation command, d) activating a voice assistant functionality of the first computing device in response to the verbal activation command, e) accessing additional sensor data associated with the vehicle, including data captured by at least one sensor and representing at least one of the position of the requestor relative to the vehicle, the position of the requestor relative to the audio capture device, an orientation of the requestor relative to the vehicle, or presence of at least one mobile computing device in communication with the vehicle controller, f) accessing additional sensor data associated with the vehicle to identify the requestor from two or more vehicle occupants, g) identifying the first computing device as one mobile computing device, of the two or more mobile computing devices, that is associated with the requestor, h) determining, based on the position of the requestor, whether the requestor is an occupant of the vehicle, i) identifying the first computing device as a mobile computing device associated with the requestor when the requestor is not an occupant of the vehicle, j) determining whether the mobile computing device or the vehicle controller on-board the vehicle is the first computing device when the requestor is an occupant of the vehicle, k) transmitting an activation signal to the first computing device, the activation signal causing activation of the respective voice assistant functionality, and/or l) transmitting a do-not-activate (DNA) signal to any other computing devices within a threshold proximity of the vehicle, the DNA signal preventing activation of the respective voice assistant functionality.

Various embodiments will be better understood when read in conjunction with the appended drawings. To the extent that the figures illustrate the functional blocks of various embodiments, the functional blocks are not necessarily indicative of a division between hardware circuitries. Thus, for example, one or more of the functional blocks (e.g., systems, devices, processors, controllers, and/or memories) may be implemented in a single piece of hardware (e.g., a general-purpose signal processor or random-access memory, hard disk, or the like) or in multiple pieces of hardware. Similarly, any program may be a stand-alone program, may be incorporated as subroutines in an operating system, may be a function(s) in an installed software package, and/or the like. It should be understood that the various embodiments are not limited to the arrangements and instrumentality shown in the drawings.

Various embodiments of methods and systems for controlling functions of an exemplary vehicle control system, including a vehicle infotainment system, are provided. It should be noted that although the various embodiments are described in connection with the automotive industry, such as for use with an automobile, one or more embodiments may be implemented in different industries and for different applications. Additionally, communication of information used in accordance with one or more embodiments may be performed with different types of communication protocols, as well as using different types of communication lines and communication buses.

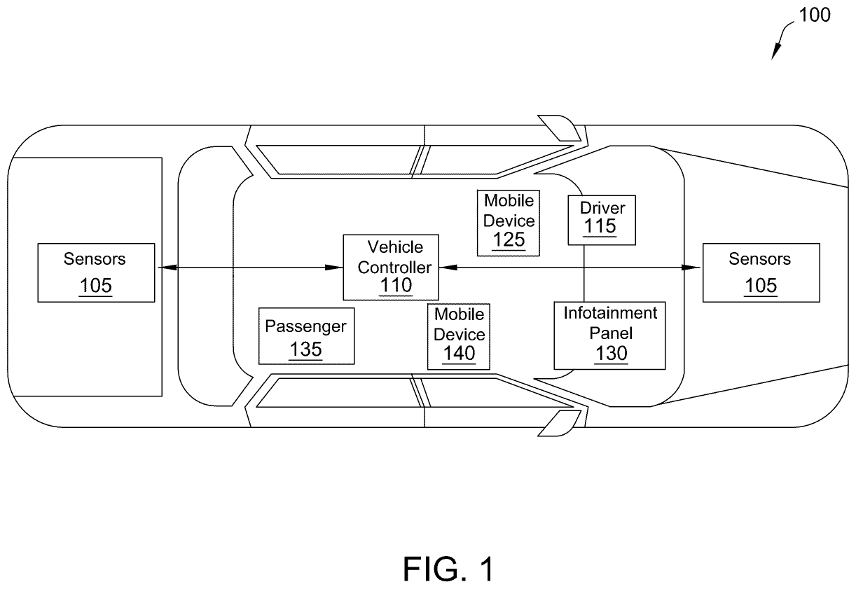

FIG. 1 depicts a top view of an exemplary vehicle 100, in accordance with one embodiment of the present disclosure. In some embodiments, vehicle 100 may be an autonomous or semi-autonomous vehicle capable of fulfilling the transportation capabilities of a traditional automobile or other vehicle. In these embodiments, vehicle 100 may be capable of sensing its environment and navigating without human input. In other embodiments, vehicle 100 is a manual vehicle or a semi-autonomous vehicle with driver assistance systems, such as, but not limited to, lane keep assistance, adaptive cruise control, and parallel parking assistance, where the vehicle may be a traditional automobile that is controlled by a driver 115.

Vehicle 100 may include a plurality of sensors 105 and a vehicle controller 110. In the example embodiment, the plurality of sensors 105 may detect the current interior and exterior environment of vehicle 100 and the location of vehicle 100, and vehicle controller 110 is configured to process and interpret sensor data captured by sensors 105 to perform various control functions. Sensors 105 may include, for example, cameras, audio capture devices (e.g., microphones), audio recorders, and computer vision. Sensors 105 may include presence sensors that detect the presence of driver 115 and one or more passengers 135 in vehicle 100. In these embodiments, sensors 105 may visually detect the occupants of vehicle (e.g., via one or more cameras), detect occupants of the vehicle using ultrawideband technology, detect the presence of fastened seatbelts, detect the weight in each seat in vehicle 100, detect heat signatures, or any other method of detecting information about driver 115 and/or passengers 135 in vehicle 100.

In some embodiments, sensors 105 include cameras, LIDAR, radar, proximity detectors, and/or other sensors 105 that provide information about the surroundings of the vehicle 100, such as, but not limited to, person(s) outside and proximate to vehicle 100, other vehicles, obstacles, traffic flow information including road signs, traffic lights, and other traffic information, and/or other environmental information.

In some embodiments, sensors 105 may additionally include, but are not limited to only including, odometer, speedometer, accelerometers, wheel sensors, radar, LIDAR, proximity sensors, ultrasonic sensors, electromagnetic sensors, wide RADAR, long distance RADAR, Global Positioning System (GPS), video devices, imaging devices, cameras, audio recorders, and computer vision. Sensors 105 may also include sensors that detect conditions of vehicle 100, such as covered distance, speed, acceleration, gear, braking, and other conditions related to the operation of vehicle 100, for example: at least one of a measurement of at least one of time, speed, direction, rate of acceleration, rate of deceleration, location, position, orientation, and rotation of the vehicle, and a measurement of one or more changes to at least one of time, speed, direction, rate of acceleration, rate of deceleration, location, position, orientation, and rotation of the vehicle. Furthermore, in some embodiments, sensors 105 may include impact sensors that detect impacts to vehicle 100, including force and direction and sensors that detect actions of vehicle 100, such the deployment of airbags.

In the exemplary embodiment, vehicle controller 110 is able to communicate with one or more remote computer devices, such as mobile device 125 of driver 115 and mobile device 140 of passenger 135. Mobile device 125 may include, but is not limited to only including, a cellular phone, a smart phone, a tablet, and/or any other portable computing device brought into and/or removed from vehicle 100. Vehicle controller 110 may communicate with mobile device(s) 125, 140 wirelessly, such as via a wireless near-field network (e.g., BLUETOOTH) or via a cellular network. In some embodiments, vehicle controller 110 may detect the presence of mobile device(s) 125, 140 within vehicle 100 based on their mobile device(s) wirelessly pairing with vehicle controller 110. Vehicle controller 110 may use data from other sensors 105, or sensors within mobile device(s) (e.g., microphone, accelerometer, gyroscope, compass, GPS device, etc.) to determine a location and/or position of each mobile device within or relative to vehicle 100.

In the example embodiment, vehicle 100 further includes an infotainment panel 130. Vehicle controller 110 may receive user input from driver 115 or passenger 135 via infotainment panel 130 and/or mobile device(s) 125, 140. Such user input may include, for example, user preferences or control commands. Vehicle controller 110 may also provide output(s) to driver 115 or passenger 135 via infotainment panel 130 and/or mobile device(s) 125, 140.

In the example embodiment, vehicle controller 110 is responsive to voice commands issued by a requestor, including driver 115 or passenger 135. As described in greater detail herein, vehicle controller 110 detects that an occupant of vehicle 100—that is, the requestor—has issued a verbal activation command, directed to voice assistant functionality of vehicle 100 (e.g., of vehicle controller 110) or to their respective mobile device 125, 140. Vehicle controller 110 is configured to (i) determine whether multiple occupants are in vehicle 100 and/or whether one or more users of vehicle 100 are outside of vehicle 100, and, if so, which occupant was the requestor of the verbal activation command, (ii) determine whether any computing devices other than vehicle controller 110 are present in vehicle 100, and (iii) determine which computing device is the intended receiver of the verbal activation command. Vehicle controller 110 may further cause activation of the voice assistant functionality of the corresponding computing device, such that the computing device is activated for receipt of additional verbal commands from the user.

In some embodiments, vehicle 100 may include autonomous or semi-autonomous vehicle-related functionality or technology. In such embodiments, the autonomous or semi-autonomous vehicle-related functionality or technology may be controlled, operated, and/or in communication with vehicle controller 110. In some embodiments, vehicle controller 110 includes a plurality of controllers associated with different sensors 105 and/or controls of the vehicle 100. In such cases, the plurality of controllers are in communication with each other, such as through a Controller Area Network (e.g., CAN bus) (not shown). Moreover, although vehicle 100 may be an automobile in the exemplary embodiment, in other embodiments, vehicle 100 may be, but is not limited to only being, a bus, a low-speed vehicle, a motorcycle, a utility task vehicle, a truck, construction equipment, and/or any other type of vehicle.

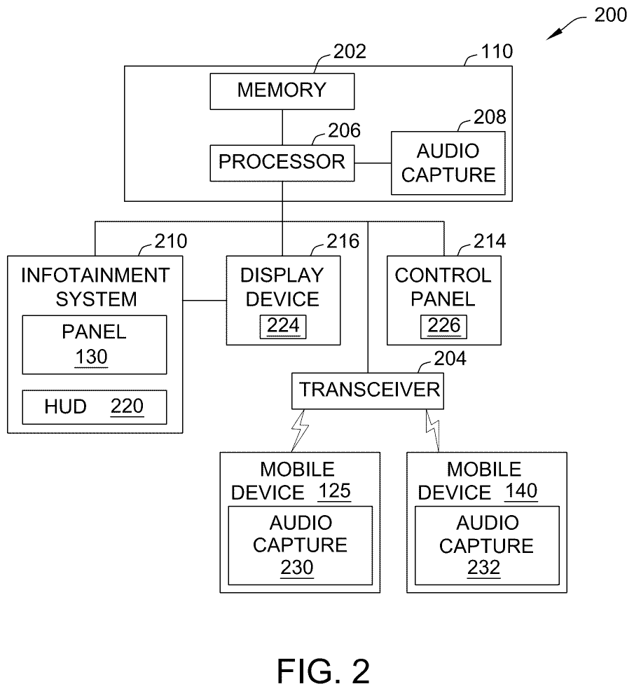

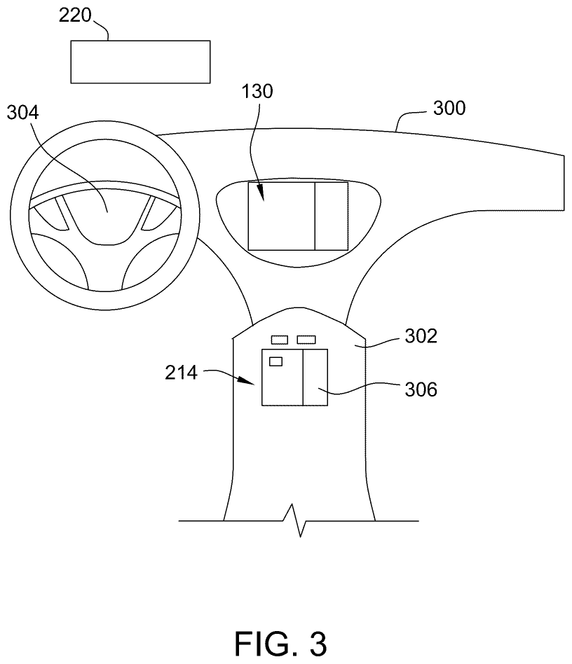

FIG. 2 is a block diagram of an exemplary vehicle control system 200 that may be used with the vehicle 100 (shown in FIG. 1), and FIG. 3 is a partial schematic view of the vehicle 100 including vehicle control system 200.

In the exemplary embodiment, vehicle control system 200 includes a memory 202, a transceiver 204, a processor 206, an audio capture device 208, a vehicle infotainment system 210, a control panel 214, and a display device 216. In some embodiments, memory 202, the transceiver 204, processor 206, and/or audio capture device 208 may be included in vehicle controller 110, which may function as a controller for the system 200 and may control or otherwise be communicatively coupled to any other component within the system 200 (e.g., the vehicle infotainment system 210, control panel 214, and/or display device 216).

Processor 206 may include one or more conventional electronic processors that interpret and execute instructions. Memory 202 may include a random-access memory (RAM), a read-only memory (ROM), and/or another type of dynamic or static storage device that stores information and instructions for execution by processor 206. The RAM, or another type of dynamic storage device, may store instructions as well as temporary variables or other intermediate information used during execution of instructions by processor 206. The ROM, or another type of static storage device, may store static information and instructions for processor 206.

Transceiver 204 may communicate with processor 206 via a communication line, and may communicate wirelessly (or, in some embodiments, via a wired connection) with mobile device(s) 125, 140. In some embodiments, transceiver 204 may communicate wirelessly with mobile device(s) 125, 140 via a BLUETOOTH protocol (Bluetooth is a registered trademark of Bluetooth Sig., Inc. of Bellevue, Wash.). In other embodiments, another wireless protocol may be used, such as a cellular connection. In the exemplary embodiment, transceiver 204 is included as part of, and may integrated within, vehicle controller 110.

In the exemplary embodiment, vehicle infotainment system 210 may be used to enable a user to access entertainment options and control options for vehicle 100. Vehicle infotainment system 210 may include, for example, one or more speakers for playing audio content, as well as one or more controls for controlling audio output from one or more of the speakers. Vehicle infotainment system 210, in some embodiments, include a display screen, such as infotainment panel 130, for displaying video or picture content in combination with audio content. In some embodiments, vehicle control system 200 also includes one or more additional display screens 224 that may be separate from or integral to infotainment panel 130. For example, a display screen 224 may be an output-only display (such a rear-entertainment), in contrast to a touch-panel based infotainment panel 130 that is also configured to receive input.

In the example embodiment, vehicle infotainment system 210 may include infotainment panel 130, as well as a heads-up display (HUD) 220, which may collectively function as a display assembly of vehicle infotainment system 210. With reference to FIG. 3, vehicle 100 includes a dashboard 300 and a center console 302. In one example embodiment, infotainment panel 130 is centrally located within dashboard 300 such that a user, or an operator/driver 115 (shown in FIG. 1), of vehicle 100 may easily view infotainment panel 130 without being distracted while operating vehicle 100. Infotainment panel 130 may be positioned close to the user's eye level to enable infotainment panel 130 to be peripherally viewed while the user is viewing the roadway ahead. In other embodiments, infotainment panel 130 may be positioned at other relative locations within vehicle 100. For example, in one embodiment, infotainment panel 130 extends along dashboard 300 behind the steering wheel. In some of these embodiments, there is a secondary display screen 304 embedded in the steering wheel and/or displayed as a heads-up icon visible to only the driver. In some embodiments, the secondary display screen 304 is in communication with infotainment system 210.

In the example embodiment, HUD 220 projects information onto the windshield of the vehicle 100, such that driver 115 may view the information without looking away from the roadway. In some embodiments, infotainment panel 130 and HUD 220 display or communicate different information to driver 115, and/or HUD 220 communicates information to driver 115 while infotainment panel 130 is operable by passenger 135 to receive input therefrom and provide output thereto.

Returning to FIG. 2, control panel 214 may communicate with the processor 206 via a communication line to transmit data to/from control panel 214, such as for control of other modules or systems of vehicle control system 200. In one embodiment, control panel 214 includes, and/or is communicatively coupled to, additional input device(s) 306 (shown in FIG. 3) that enable an input to be received from a user for control of the vehicle control system 200. Such input devices 306 may include, for example, a touchpad or mechanical controls, such as, but not limited to only being, buttons, switches, knobs, and/or levers. Control panel 214 may have a dedicated control module or unit that processes the control inputs and/or that processes the data to be displayed to occupant(s) of vehicle 100. Alternatively, such control functions may be processed by processor 206 (e.g., as part of vehicle controller 110). For example, control panel 214, vehicle infotainment system, and/or the components of any other sub-systems of vehicle control system 200 may be communicatively coupled to processor 206.

In the example embodiment, vehicle controller 110, mobile device 125, and mobile device 140 each include an audio capture device 208, 230, and 232, respectively. Audio capture devices 140 may include, for example, microphones or other suitable equipment to capture audible sounds, specifically words spoken by a requestor, who may be an occupant of vehicle 100. Each audio capture device may have respective characteristics or capabilities thereof, such as a physical range over which the device can capture sound, and the like. Audio capture devices 140, alone or in combination, may be used to determine a location or position of the source of the detected sound within vehicle 100 (e.g., a location or position of a requestor).

When multiple persons and/or computing devices—other than vehicle controller 110—are present in or are in close proximity to vehicle 100, vehicle controller 110 determines the intended recipient or destination of a verbal activation command issued by a requestor. More specifically, each verbal activation command is detected by vehicle controller 110 via audio capture device 208. Vehicle controller 110 executes various processes to contextualize each verbal activation command and to direct the command to the appropriate device. For example, in the exemplary embodiment, commands issued by different vehicle users may be directed to different computing devices. In some embodiments, if a requestor is outside of vehicle 100, the command may have been intended to be directed to the requestor's personal mobile computing device, whereas if the requestor is inside of vehicle 100, the command may have been intended to be directed to vehicle controller 110 (e.g., to perform some function, such as displaying information on infotainment panel 130 or HUD 220). In another example, when a driver and a passenger are present in a vehicle at the same time, a command issued by a driver requestor may be intended for vehicle controller 110, whereas a command issued by a passenger requestor may be intended for the passenger's personal mobile computing device. These processes identify the context of the command and direct the command accordingly, as described further herein, and may be executed using processor 206 according to instructions stored in memory 202.

In some embodiments, vehicle controller 110 determines how many occupants of vehicle 100 are present. Occupants may include driver 115 and/or one or more passenger(s) 135. In some cases, occupants of vehicle 100 may be referred to as users of the vehicle 100 and may include persons outside of vehicle 100 but in close proximity to the vehicle 100. A person may be considered in close proximity to vehicle 100 when the person is within a predefined range of vehicle 100, such as, for example 5 feet (ft), 10 ft, 50 ft, 100 ft, etc., and this predefined range may be correlated to the capabilities of audio capture device 208. Vehicle controller 110 may detect users outside of vehicle 100 by accessing sensor data captured by sensors 105 (shown in FIG. 1), such as cameras, LIDAR, RADAR, proximity sensors, etc.

Vehicle controller 110 may determine of a number or presence of occupants using sensor data captured by sensors 105. For example, the sensor data may include audio data captured by audio capture device 208 that represents two or more different voices. As another example, the sensor data may include presence data captured or generated by presence sensors (e.g., seatbelt detection, weight detection, occupant detecting cameras, thermal detection, computer-vision detection, etc.).

When multiple occupants are present, vehicle controller 110 is configured to identify which of the occupants was the requestor that issued the detected verbal activation command. In some instances, vehicle controller 110 may determine whether the verbal activation command was issued (spoken) within or in close proximity to vehicle 100. For example, vehicle controller 110 may use data captured by audio capture device 208 (e.g., a loudness level, directionality, etc.) and/or stored data identifying a location of audio capture device 208 within vehicle 100 to determine where the command initiated, which is representative of a location and/or position of the requestor. In alternative embodiments, vehicle controller 110 may determine the requestor using sensor data captured by mobile device(s) 125, 140. For example, audio capture device 230 of mobile device 125 may capture the verbal activation command and may transmit a signal to vehicle controller 110 related to the captured command. Vehicle controller 110 may be configured to to use the loudness, directionality, and/or other characteristic of the audio data detected by the mobile device(s) 125 to better identify the location from which the command originated.

In some embodiments, vehicle controller 110 may store (e.g., within memory 202) a plurality of user profiles respectively associated with a plurality of users of vehicle 100. Each user profile may include a voice sample or a sample profile of the respective user, and vehicle controller 110 may compare the verbal activation command to the voice sample and/or to the profile, to determine which vehicle occupant issued the command (i.e., which vehicle occupant was the requestor). In still other instances, vehicle controller 110 may access other sensor data, such as visual data captured by an interior camera, to identify the requestor.

In some embodiments, after the requestor is identified, vehicle controller 110 directs the command to a computing device contextually associated with the requestor. When multiple computing devices are present—such as vehicle controller 110, mobile device 125, and mobile device 140—vehicle controller 110 is configured to determine which of the computing devices is contextually associated with the requestor. Initially, vehicle controller 110 may detect the presence of multiple computing devices based on the pairing of computing devices with vehicle controller 110 (e.g., via transceiver 204, via a wireless connection). In some instances, vehicle controller 110 determines a location, position, and/or orientation of each computing device within vehicle 100 (e.g., by accessing sensor data from the mobile devices, using sensor data captured by vehicle sensors 105, and/or any other determination method that enables controller 110 to function as described herein), and associates a computing device with a respective user based on the relative location, position, and/or orientation thereof. For example, when a driver 115 and a passenger 135 are present in vehicle 100, and vehicle controller 110 determines that passenger 135 was the requestor (e.g., based on loudness, directionality, etc.), vehicle controller 110 may identify mobile device 140 as the computing device contextually associated with passenger 135, because mobile device 140 is co-located with passenger 135 or is in a closer proximity to passenger 135 than mobile device 125 is relative to passenger 135. Where there are multiple occupants of vehicle 100, vehicle controller 110 may be associated with driver 115, by default. In some embodiments, vehicle controller 110 may detect or otherwise determine that a computing device present in vehicle 100 has no voice-activation functionality, and may ignore that computing device in any further processing.

In other embodiments, where there is only one person occupying the vehicle, vehicle controller 110 may still detect that there are multiple computing devices present, such as both vehicle controller 110 and mobile device 125 of driver 115. In these instances, vehicle controller 110 determines which device was the intended recipient of the command issued by the requestor. For example, vehicle controller 110 may determine whether the requestor (e.g., driver 115) is within vehicle 100, in which case the intended recipient was (likely) vehicle controller 110, whereas in contrast, when the requestor is outside of and is in close proximity to vehicle 100, the intended recipient was (likely) the requestor's mobile device 125. Vehicle controller 110 may determine the position of the requestor relative to vehicle 100, such as relative to an audio capture device 208, using various sensor data captured by sensors 105 (e.g., cameras, proximity sensors, thermal sensors, RADAR, LiDAR, microphones, seatbelt detection, weight detection etc.).

In some embodiments, vehicle controller 110 detects the verbal activation command but determines that there are no occupants of vehicle 100 (e.g., using various sensor data as described elsewhere herein) and/or that there are no persons in close proximity (e.g., within a threshold proximity distance) to vehicle 100. In such instances, vehicle controller 110 may take no action related to the command, and the intended recipient computing device (e.g., a mobile device 125/140) may respond to the verbal activation command as normal.

Therefore, in the example embodiment, there are three primary conditions under which the vehicle controller 110 operates in response to the verbal activation command, although any number of conditions may exist, including any alternatives or variations as described herein.

A first condition is that no person is in and/or in close proximity to vehicle 100 when the verbal activation command is issued by a requestor. Under this condition, vehicle controller 110 does not response to a detected verbal activation command, and the intended recipient computing device (e.g., a mobile device 125/140) may respond to the verbal activation command as normal.

A second condition is that there is one occupant of vehicle 100. Under this condition, vehicle controller 110 determines the one occupant of vehicle 100 is the requestor. The one occupant may be a driver (e.g., driver 115) or a passenger (e.g., passenger 135).

A third condition is that there are multiple occupants of vehicle 100, such as a driver (e.g., driver 115) and one or more passengers (e.g., passenger 135). Vehicle controller 110 may first determine which occupant was the requestor, as described herein.

With respect to these conditions, as described herein, vehicle controller 110 may detect the verbal activation command (e.g., via one or more audio capture devices 208) and may determine whether there are any occupants of vehicle 100. For example, vehicle controller 110 uses sensor data-from sensors such as presence sensors, weight sensors, presence/absence of connected key fobs, camera or other image sensors, as described herein-to determine whether there are any occupants of vehicle 100. Vehicle controller 110 may determine there are no occupants of vehicle 100 and/or that the requestor is not within a threshold proximity of vehicle 100; there is one occupant of vehicle 100 (or one person within a threshold proximity of vehicle 100) and therefore is the requestor; or there are multiple occupants of vehicle 100 and further processing is needed to determine the requestor and/or determine the intended recipient of the verbal activation command. In addition, vehicle controller 110 may determine that the vehicle's voice assistant is the intended recipient of the verbal activation command based on the content of the command. For example, vehicle controller 110 may determine that the vehicle's voice assistant is the intended recipient of verbal activation commands such as “Hey Google, turn up the music”, indicating that the user desires that the volume of the music be increased, or “Hey Google, turn up the heat”, indicating that the user desires that the set temperature of the vehicle HVAC system be increased. These are examples of verbal activation commands requesting an action that the vehicle's voice assistant is best able to perform (e.g., turn up the volume on the vehicle audio system or increase the set temperature of the vehicle HVAC system).”

Under the second or third conditions, vehicle controller 110 may determine whether any mobile computing device (e.g., mobile computing device(s) 125/140) is present within vehicle 100. If no mobile computing device is present, vehicle controller 110 may respond to the verbal activation command. If one or more mobile computing device(s) is present, vehicle controller 110 may determine a location, position, and/or orientation of the requestor relative to audio capture device 208 and/or relative to the one or more mobile computing device(s) and, based thereon, determine whether vehicle controller 110 or the mobile computing device is the intended recipient of the verbal activation command. If vehicle controller 110 is the (determined) intended recipient, vehicle controller 110 responds to the command, and vehicle controller 110 may transmit a signal (e.g., an override signal) to the mobile computing device, the signal instructing the mobile computing device to not respond to the command. If the mobile computing device is the (determined) intended recipient, vehicle controller 110 may take no action, permitting the mobile computing device to respond as normal, or vehicle controller 110 may transmit a signal to the mobile computing device, the signal causing the mobile computing device to respond. More specifically, after vehicle controller 110 has performed any applicable processes to determine which computing device—out of a plurality of computing devices present relative to vehicle 100—was the intended recipient of the verbal activation command, vehicle controller 110 activates the corresponding computing device in response to the verbal activation command. In particular, vehicle controller 110 causes activation of the voice assistant functionality of that computing device, such that the computing device is activated to receive subsequent commands and perform associated functions.

In some embodiments, vehicle controller 110 activates the corresponding computing device by transmitting an activation signal to the computing device. The activation signal includes instructions for the computing device to process the verbal activation command and to activate the corresponding voice assistant functionality. Additionally or alternatively, vehicle controller 110 may transmit a “do not activate” (DNA) signal to any other detected computing devices that are present. The DNA signal includes instructions for the receiving computing device to ignore or to otherwise not respond to the verbal activation command. When vehicle controller 110 is the only other computing device other than the intended recipient computing device, vehicle controller 110 may ignore or otherwise not respond to the verbal activation command, or may transmit a DNA signal to another component of vehicle control system 200 (e.g., control panel 214, infotainment system 210, etc.) to prevent that component from inadvertently activating in response to the command. Additionally or alternatively, where the intended recipient computing device is vehicle controller 110 itself, vehicle controller 110 (via processor 206) may activate a voice assistant functionality or transmit an activation signal to another component of vehicle control system 200 (e.g., control panel 214, infotainment system 210, etc.) to activate a voice assistant functionality. Once the intended voice assistant functionality is activated or executed on the corresponding computing device, that computing device is ready to receive subsequent commands.

In some embodiments, one or more of the processing steps described herein is performed by a mobile device connected to the vehicle controller 110, such as mobile device 125 or mobile device 140.

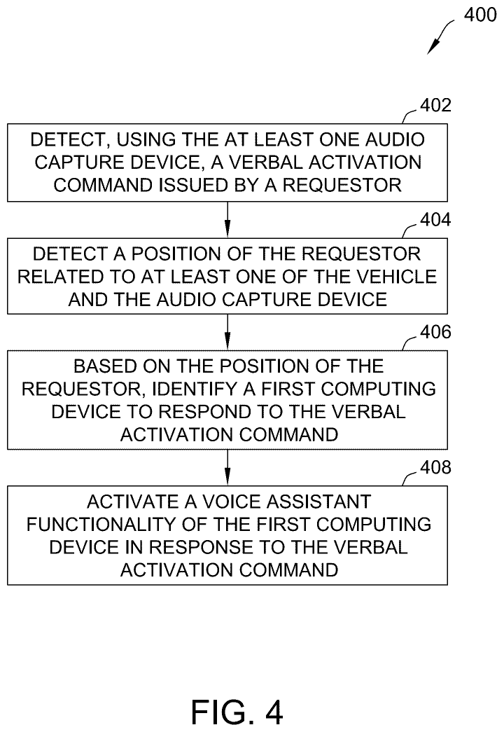

FIG. 4 illustrates an exemplary flowchart of a process 400 for contextually activating voice control components of communicatively coupled computing devices, using system 200 (shown in FIG. 2), in accordance with at least one embodiment. In the exemplary embodiment, the steps of process 400 are performed by vehicle controller 110 of vehicle 100 (both shown in FIG. 1).

In the exemplary embodiment, vehicle controller 110 detects 402, using at least one audio capture device (e.g., audio capture device 208, shown in FIG. 2), a verbal activation command issued by a requestor (e.g., driver 115, passenger 135, both shown in FIG. 1). Vehicle controller 110 detects or determines 404 a position, location, and/or orientation (which may be collectively referred to as “position”) of the requestor relative to at least one of the vehicle or the audio capture device. Based on the determined position, vehicle controller 110 identifies 406 a first computing device to respond to the verbal activation command. Vehicle controller 110 also activates 408 a voice assistant functionality of the first computing device in response to the verbal activation command.

Process 400 may include additional, fewer, or alternative steps.

In some embodiments, vehicle controller 110 detects 404 the position of the requestor by accessing additional sensor data associated with the vehicle. The additional sensor data may include data captured by at least one sensor (e.g., sensors 105, shown in FIG. 1) and representing at least one of the position of the requestor relative to the vehicle, the position of the requestor relative to the audio capture device, an orientation of the requestor relative to the vehicle, or presence of at least one mobile computing device (e.g., mobile device 125, mobile device 140) in communication with vehicle controller 110. The additional sensor data may be captured by at least one of a microphone, camera, or presence sensor of the vehicle. The data representing presence of at least one mobile computing device in communication with vehicle controller 110 includes wireless pairing data identifying the at least one mobile computing device is currently wirelessly paired to vehicle controller 110.

In some embodiments, vehicle controller 110 is in communication with two or more mobile computing devices. As part of process 400, vehicle controller 110 may access additional sensor data associated with the vehicle to identify the requestor from two or more vehicle occupants, and identify 404 the first computing device as one mobile computing device, of the two or more mobile computing devices, that is associated with the requestor.

In some embodiments, vehicle controller 110 is in communication with a mobile computing device. As part of process 400, vehicle controller 110 may determine, based on the position of the requestor, whether the requestor is an occupant of the vehicle, identify 404 the first computing device as a mobile computing device associated with the requestor when the requestor is not an occupant of the vehicle, and determine whether the mobile computing device or vehicle controller 110 is the first computing device when the requestor is an occupant of the vehicle.

In some embodiments of process 400, activating 406 may include transmitting an activation signal to the first computing device, the activation signal causing activation of the respective voice assistant functionality, and/or transmitting a do-not-activate (DNA) signal to any other computing devices within a threshold proximity of the vehicle, the DNA signal preventing activation of the respective voice assistant functionality.

In some embodiments of process 400, the (identified 404 and activated 406) first computing device is vehicle controller 110, on-board the vehicle. In some embodiments, vehicle controller 110 is in communication with a mobile computing device, and the (identified 404 and activated 406) first computing device is the mobile computing device.

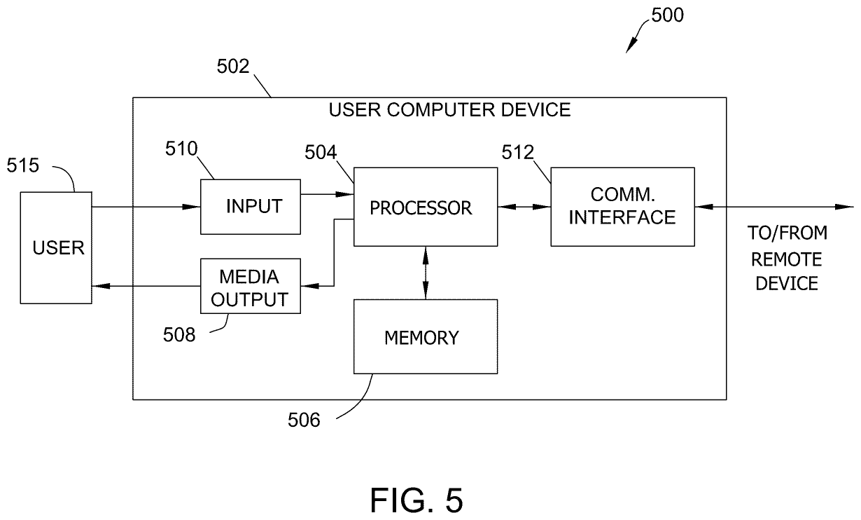

FIG. 5 depicts an exemplary configuration 500 of some computer devices shown in FIGS. 1 and 2, in accordance with one embodiment of the present disclosure. User computer device 502 may be operated by a user 515. In the exemplary embodiment, user 515 may include a requestor, such as driver 115 and/or passenger 135 (both shown in FIG. 1). User computer device 502 may include, but is not limited to only including, vehicle controller 110, mobile device 125, mobile device 140 (all shown in FIG. 1), and infotainment system 210 (shown in FIG. 2).

User computer device 502 may include a processor 504 for executing instructions. In some embodiments, executable instructions are stored in a memory area 506. Processor 504 may include one or more processing units (e.g., in a multi-core configuration). Memory area 506 may be any device allowing information such as executable instructions and/or transaction data to be stored and retrieved. Memory area 506 may include one or more computer readable media.

User computer device 502 may also include at least one media output component 508 for presenting information to user 515. Media output component 508 may be any component capable of conveying information to user 515. In some embodiments, media output component 508 may include an output adapter (not shown) such as a video adapter and/or an audio adapter. An output adapter may be operatively coupled to processor 504 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 508 may be configured to present a graphical user interface (e.g., a web browser and/or a client application) to user 515, such as through infotainment panel 130 (shown in FIG. 1). A graphical user interface (GUI) may include, for example, route information, alerts, message, instructions, etc.

In some embodiments, user computer device 502 may include an input device 510 for receiving input from user 515. User 501 may use input device 510 to, without limitation, entering or updating one or more user preferences. Input device 510 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 508 and input device 510.

User computer device 502 may also include a communication interface 512, communicatively coupled to a remote device such as mobile device 125 or vehicle controller 110. Communication interface 512 may include, for example, a wired or wireless network adapter and/or a wireless data transceiver for use with a mobile telecommunications network.

Stored in memory area 506 are, for example, computer readable instructions for providing a user interface to user 515 via media output component 508 and, optionally, receiving and processing input from input device 510. A user interface may include, among other possibilities, a web browser and/or a client application. Web browsers enable users, such as user 515, to display and interact with media and other information typically embedded on a web page or a website from vehicle controller 110.

Processor 504 executes computer-executable instructions for implementing aspects of the disclosure. In some embodiments, processor 504 is transformed into a special purpose microprocessor by executing computer-executable instructions or by otherwise being programmed. For example, processor 504 may be programmed with the instructions such as illustrated in FIG. 4.

In some embodiments, user computer device 502 may include, or be in communication with, one or more sensors, such as sensors 105 (shown in FIG. 1) and audio capture devices 208, 230, 232 (shown in FIG. 3). User computer device 502 may be configured to receive data from the one or more sensors and store the received data in memory area 506. Furthermore, user computer device 502 may be configured to transmit the sensor data to a remote computer device, such as vehicle controller 110 or mobile device 125, through communication interface 512.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on vehicles, stations, nodes, or mobile devices, or associated with smart infrastructures and/or remote servers), and/or through implementation of computer-executable instructions stored on non-transitory computer-readable media or medium. Unless described herein to the contrary, the various steps of the several processes may be performed in a different order, or simultaneously in some instances.

Additionally, the computer systems discussed herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/sub-steps, and store collected data (e.g., user vocal profiles, user command histories, user preferences, etc.) in a memory or storage associated therewith. This stored information may be used by the respective processing elements to make the determinations necessary to perform other relevant processing steps, as described above.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, vocal samples/profiles, other audio samples with loudness/directional characteristics identified, etc.. The machine learning programs may utilize deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to determine user preferences, recognize user voices, identify correspondence or associated between a user and a commend, or identify correspondence between a user and their computing device.

Based upon these analyses, the processing element may learn how to identify characteristics and patterns that may then be applied to analyzing image data, model data, and/or other data. For example, the processing element may learn, to identify trends in commands issued by one vehicle user vs. another vehicle user. The processing element may also learn how to identify trends that may not be readily apparent based upon collected vehicle information.

The exemplary systems and methods described and illustrated herein therefore significantly increase the safety of operation of vehicles by reducing the potential for distraction of the driver based on inadvertent voice activation.

The present systems and methods are further advantageous over conventional techniques the embodiments herein are not confined to a single type of vehicle and/or situation but may instead allow for versatile operation within multiple different types of vehicles, including ground craft, watercraft, aircraft, and spacecraft. Accordingly, these novel techniques are of particular value to vehicle manufacturers who desire to have these methods and systems available for the users of their vehicles.

Exemplary embodiments of systems and methods for contextually activating voice control features are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

In the present specification and the claims, reference is made to a number of terms, which shall be defined to have the following meanings.

The singular forms “a,” “an,” and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. The above examples are exemplary only, and thus are not intended to limit in any way the definition and/or meaning of the term processor and processing device.

In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. The methods described herein may be encoded as executable instructions embodied in a computer readable medium, including, without limitation, a storage device and/or a memory device. Such instructions, when executed by a processing device, cause the processing device to perform at least a portion of the methods described herein.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

A computer program of one embodiment is embodied on a computer-readable medium. In an example, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components are in the form of computer-executable instructions embodied in a computer-readable medium.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A vehicle controller associated with a vehicle comprising:
at least one memory device;
at least one audio capture device; and
at least one processor in communication with the at least one memory device and the at least one audio capture device, wherein the at least one processor is programmed to:
detect, using the at least one audio capture device, a verbal activation command issued by a requestor;
detect a position of the requestor relative to at least one of the vehicle and the at least one audio capture device;
based on the position of the requestor, identify a first computing device as an intended recipient of the verbal activation command; and
activate a voice assistant functionality of the first computing device in response to the verbal activation command.

2. The vehicle controller of claim 1, wherein the first computing device is the vehicle controller on-board the vehicle.

3. The vehicle controller of claim 1, wherein the vehicle controller is in communication with a mobile computing device, and the first computing device is the mobile computing device.

4. The vehicle controller of claim 1, wherein the at least one processor is further programmed to detect the position of the requestor by accessing additional sensor data associated with the vehicle, the additional sensor data including data captured by at least one sensor and representing at least one of the position of the requestor relative to the vehicle, the position of the requestor relative to the audio capture device, an orientation of the requestor relative to the vehicle, or presence of at least one mobile computing device in communication with the vehicle controller.

5. The vehicle controller of claim 4, wherein the additional sensor data is captured by at least one of a microphone, camera, or presence sensor of the vehicle.

6. The vehicle controller of claim 4, wherein the data representing presence of at least one mobile computing device in communication with the vehicle controller includes wireless pairing data identifying the at least one mobile computing device is currently wirelessly paired to the vehicle controller.

7. The vehicle controller of claim 1, wherein the vehicle controller is in communication with two or more mobile computing devices, the at least one processor further programmed to:
access additional sensor data associated with the vehicle to identify the requestor from two or more vehicle occupants; and
identify the first computing device as one mobile computing device, of the two or more mobile computing devices, that is associated with the requestor.

8. The vehicle controller of claim 1, wherein the at least one processor is further programmed to:
determine, based on the position of the requestor, whether the requestor is an occupant of the vehicle;
identify the first computing device as a mobile computing device associated with the requestor when the requestor is not an occupant of the vehicle; and
determine whether the mobile computing device or the vehicle controller on-board the vehicle is the first computing device when the requestor is an occupant of the vehicle.

9. The vehicle controller of claim 1, wherein the at least one processor is further programmed to activate the voice assistant functionality of the first computing device by at least one of:
transmitting an activation signal to the first computing device, the activation signal causing activation of the respective voice assistant functionality; or
transmitting a do-not-activate (DNA) signal to any other computing devices within a threshold proximity of the vehicle, the DNA signal preventing activation of the respective voice assistant functionality.

10. A computer-implemented method for contextually activating voice control components of communicatively coupled computing devices, the method implemented by a vehicle controller including at least one memory device, at least one audio capture device, and at least one processor in communication with the at least one memory device and the at least one audio capture device, the method comprising:
detecting, using the at least one audio capture device, a verbal activation command issued by a requestor;
detect a position of the requestor relative to at least one of the vehicle and the at least one audio capture device;
based on the position of the requestor, identifying a first computing device as an intended recipient of the verbal activation command; and
activating a voice assistant functionality of the first computing device in response to the verbal activation command.

11. The computer-implemented method of claim 10, wherein said detecting the position of the requestor comprises accessing additional sensor data associated with the vehicle, the additional sensor data including data captured by at least one sensor and representing at least one of the position of the requestor relative to the vehicle, the position of the requestor relative to the audio capture device, an orientation of the requestor relative to the vehicle, or presence of at least one mobile computing device in communication with the vehicle controller.

12. The computer-implemented method of claim 10, wherein the vehicle controller is in communication with two or more mobile computing devices, the method further comprising:
accessing additional sensor data associated with the vehicle to identify the requestor from two or more vehicle occupants; and
identifying the first computing device as one mobile computing device, of the two or more mobile computing devices, that is associated with the requestor.

13. The computer-implemented method of claim 10, further comprising:
determining, based on the position of the requestor, whether the requestor is an occupant of the vehicle;
identifying the first computing device as a mobile computing device associated with the requestor when the requestor is not an occupant of the vehicle; and
determining whether the mobile computing device or the vehicle controller on-board the vehicle is the first computing device when the requestor is an occupant of the vehicle.

14. The computer-implemented method of claim 12, wherein said activating comprises at least one of:
transmitting an activation signal to the first computing device, the activation signal causing activation of the respective voice assistant functionality; or
transmitting a do-not-activate (DNA) signal to any other computing devices within a threshold proximity of the vehicle, the DNA signal preventing activation of the respective voice assistant functionality.

15. A vehicle comprising:
a plurality of sensors disposed within and exterior to the vehicle; and
a vehicle controller on-board the vehicle, the vehicle controller comprising at least one memory device, at least one audio capture device, and at least one processor in communication with the at least one memory device and the at least one audio capture device, wherein the vehicle controller is programmed to:
detect, using the at least one audio capture device, a verbal activation command issued by a requestor;
detect a position of the requestor relative to at least one of the vehicle and the at least one audio capture device;
based on the position of the requestor, identify a first computing device as an intended recipient of the verbal activation command; and
activate a voice assistant functionality of first computing device in response to the verbal activation command.

16. The vehicle of claim 15, wherein the first computing device is the vehicle controller on-board the vehicle.

17. The vehicle of claim 15, wherein the vehicle controller is in communication with a mobile computing device, and the first computing device is the mobile computing device.

18. The vehicle of claim 15, wherein the vehicle controller is further programmed to detect the position of the requestor by accessing additional sensor data associated with the vehicle, the additional sensor data including data captured by at least one sensor and representing at least one of the position of the requestor relative to the vehicle, the position of the requestor relative to the audio capture device, an orientation of the requestor relative to the vehicle, or presence of at least one mobile computing device in communication with the vehicle controller.

19. The vehicle of claim 18, wherein the additional sensor data is captured by at least one of a microphone, camera, or presence sensor of the vehicle.

20. The vehicle of claim 15, wherein the vehicle controller is in communication with a mobile computing device and is further programmed to:
determine, based on the position of the requestor, whether the requestor is an occupant of the vehicle;
identify the first computing device as a mobile computing device associated with the requestor when the requestor is not an occupant of the vehicle; and
determine whether the mobile computing device or the vehicle controller on-board the vehicle is the first computing device when the requestor is an occupant of the vehicle.
